(19) United States
(12) Patent Application Publication
(10) Pub. No.: US 2025/0303663 A1
(43) Pub. Date: Oct. 2, 2025

(54) COMPOSITE PANEL ASSEMBLIES HAVING INTERLOCKING JOINTS AND METHODS FOR MAKING THE SAME

(71) Applicant: General Electric Company, Schenectady, NY (US)

(72) Inventors: Daniel Gene Dunn, Guilderland, NY (US); Douglas Glenn Decesare, Queensbury, NY (US); Jared Hogg Weaver, Clifton Park, NY (US); Scott Roger Finn, Montgomery, OH (US)

(21) Appl. No.: 18/619,290

(22) Filed: Mar. 28, 2024

(51) Int. Cl. B32B 3/06; B32B 3/12; B32B 9/00; B32B 9/04; B33Y 80/00

(52) U.S. Cl. CPC B32B 3/06; B32B 3/12; B32B 9/005; B32B 9/04; B33Y 80/00; B32B 2250/40

(57) ABSTRACT

A composite panel assembly includes a first composite panel having a first core structure. The first core structure includes a first core structure first face and a first core structure second face. The first composite panel further includes a first composite panel first composite sheet and a first composite panel second composite sheet. The first composite panel first composite sheet bonded to the first core structure first face and a first composite panel second composite sheet bonded to the first core structure second face. An interlocking feature is defined in the first core structure. The composite panel assembly further includes a component having a portion that extends into the interlocking feature such that an interlocking mechanical joint is formed between the first composite panel and the component.

### FIELD

The present disclosure relates to composite panel assemblies having a composite panel and a component coupled together to form an interlocking joint.

### BACKGROUND

Modern machinery such as airplanes, automobiles, marine, rockets, space vehicles or industrial equipment may be subject to extreme operating conditions that include high temperatures, high pressure, and high speeds. Reinforced ceramic matrix composites (“CMCs”) comprising fibers dispersed in continuous ceramic matrices of the same or a different composition are well suited for structural applications because of their toughness, thermal resistance, high-temperature strength, and chemical stability. Such composites typically have high strength-to-weight ratio and maintain this attribute over a broad range of temperatures that exceeds metallic alloys. This renders them attractive in applications in which weight is a concern and high temperature structural attributes highly constrain the design of components and systems, such as in aeronautics and space vehicle applications. Their stability at high temperatures renders CMCs very suitable in applications in which components are in contact with a high-temperature gas, such as in a gas turbine engine and re-entry conditions of space vehicles in terrestrial and non-terrestrial environments.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates an exploded perspective view of an exemplary composite panel with a plurality of cells, the cells being in a hexagonal shape, in accordance with embodiments of the present disclosure;

FIG. 2 illustrates a partially exploded schematic view of an exemplary composite panel assembly having a mortise and tenon joint or a dado joint in accordance with embodiments of the present disclosure;

FIG. 3 illustrates a schematic view of the composite panel assembly shown in FIG. 2 fully assembled in accordance with embodiments of the present disclosure;

FIG. 4 illustrates a partially exploded schematic view of another exemplary composite panel assembly having a dovetail joint in accordance with embodiments of the present disclosure;

FIG. 5 illustrates schematic the composite panel assembly shown in FIG. 4 fully assembled in accordance with embodiments of the present disclosure;

FIG. 6 illustrates a partially exploded schematic view of another exemplary composite panel assembly having a T-shaped joint in accordance with embodiments of the present disclosure;

FIG. 7 illustrates schematic the composite panel assembly shown in FIG. 6 fully assembled in accordance with embodiments of the present disclosure;

FIG. 8 illustrates a partially exploded schematic view of the composite panel assembly, in which the interlocking feature is a aperture with a composite grommet disposed therein, in accordance with embodiments of the present disclosure;

FIG. 9 illustrates a cross sectional view of the composite panel shown from along the line 9-9 shown in FIG. 8, in accordance with embodiments of the present disclosure; and

FIG. 10 is a flowchart of an exemplary method of manufacturing a composite panel assembly in accordance with embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and systems. In at least some instances, the approximating language may correspond to the precision of an instrument for measuring the value, or the precision of the methods or machines for constructing or manufacturing the components and systems. For example, the approximating language may refer to being within a 1, 2, 4, 5, 10, 15, or 20 percent margin in either individual values, range(s) of values and endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the terms “first”, “second”, and “third” may be used interchangeably to distinguish one component from another and are not intended to signify location or importance of the individual components.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

As used herein, the term “integral” as used to describe a structure refers to the structure being formed of a continuous material or group of materials with no seams, connections joints, or the like. The integral structure described herein may be formed through additive manufacturing to have the described structure, or alternatively through a casting process, etc. The term “unitary” as used herein denotes that the final component has a construction in which the integrated portions are inseparable and is different from a component comprising a plurality of separate component pieces that have been joined together but remain distinct and the single component is not inseparable (i.e., the pieces may be re-separated). Thus, unitary components may comprise generally substantially continuous pieces of material or may comprise a plurality of portions that are permanently bonded to one another. In any event, the various portions forming a unitary component are integrated with one another such that the unitary component is a single piece with inseparable portions.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, ceramic matrix composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon, silicon carbide, zirconium carbide), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃ 2SiO₂), as well as glassy aluminosilicates.

In certain embodiments, the reinforcing fibers may be bundled or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine, space vehicle structure, and propulsion components used in higher temperature sections, such as airfoils (e.g., turbines, and vanes), combustors, shrouds and other like components, nozzles, transition ducts, thermal protection systems, TPS, aerodynamic control surfaces and leading edges that would benefit from the lighter-weight and higher temperature capability these materials can offer.

As used herein, the term “additive manufacturing” refers generally to manufacturing technology in which components are manufactured in a layer-by-layer manner. An exemplary additive manufacturing machine may be configured to utilize any suitable additive manufacturing technology. The additive manufacturing machine may utilize an additive manufacturing technology that includes a powder bed fusion (PBF) technology, such as a direct metal laser melting (DMLM) technology, a selective laser melting (SLM) technology, a directed metal laser sintering (DMLS) technology, or a selective laser sintering (SLS) technology. In an exemplary PBF technology, thin layers of powder material are sequentially applied to a build plane and then selectively melted or fused to one another in a layer-by-layer manner to form one or more three-dimensional objects. Additively manufactured objects are generally monolithic in nature and may have a variety of integral sub-components.

Additionally or alternatively suitable additive manufacturing technologies may include, for example, Binder Jet technology, Fused Deposition Modeling (FDM) technology, Direct Energy Deposition (DED) technology, Laser Engineered Net Shaping (LENS) technology, Laser Net Shape Manufacturing (LNSM) technology, Direct Metal Deposition (DMD) technology, Digital Light Processing (DLP) technology, and other additive manufacturing technologies that utilize an energy beam or other energy source to solidify an additive manufacturing material such as a powder material. In fact, any suitable additive manufacturing modality may be utilized with the presently disclosed the subject matter.

Additive manufacturing technology may generally be described as fabrication of objects by building objects point-by-point, line-by-line, layer-by-layer, typically in a vertical direction. Other methods of fabrication are contemplated and within the scope of the present disclosure. For example, although the discussion herein refers to the addition of material to form successive layers, the presently disclosed subject matter may be practiced with any additive manufacturing technology or other manufacturing technology, including layer-additive processes, layer-subtractive processes, or hybrid processes.

The additive manufacturing processes described herein may be used for forming components using any suitable material. For example, the material may be metal, ceramic, polymer, epoxy, photopolymer resin, plastic, or any other suitable material that may be in solid, powder, sheet material, wire, or any other suitable form, or combinations thereof. Additionally, or in the alternative, exemplary materials may include metals, ceramics, or binders, as well as combinations thereof. Exemplary ceramics may include ultra-high-temperature ceramics, or precursors for ultra-high-temperature ceramics, such as polymeric precursors. Each successive layer may be, for example, between about 10 μm and 200 μm, although the thickness may be determined based on any number of parameters and may be any suitable size.

As used herein, the term “build plane” refers to a plane defined by a surface upon which an energy beam impinges to selectively irradiate and thereby consolidate powder material during an additive manufacturing process. Generally, the surface of a powder bed defines the build plane. During irradiation of a respective layer of the powder bed, a previously irradiated portion of the respective layer may define a portion of the build plane. Prior to distributing powder material across a build module, a build plate that supports the powder bed generally defines the build plane.

As used herein, the term “consolidate” or “consolidating” refers to densification and solidification of powder material as a result of irradiating the powder material, including by way of melting, fusing, sintering, or the like.

Of particular interest in the field of CMCs is the joining of one CMC subcomponent, or preform, to another CMC or ceramic subcomponent to form a complete component structure. For instance, the joining of one CMC subcomponent to another may arise when the shape complexity of an overall complete structure may be too complex to lay-up as a single part. Another instance where joining of one CMC subcomponent to another may arise is when a large complete structure is difficult to lay-up as a single part, and multiple subcomponents, or preforms, are manufactured and joined to form the large complete structure. Fabrication of complex composite components may require complex tooling, and may involve forming fibers over small radii, both of which lead to challenges in manufacturability. Current procedures for bonding CMC subcomponents include, but are not limited to, diffusion bonding, reaction forming, melt infiltration, brazing, adhesives, or the like. Of particular concern in these CMC component structures that are formed of conjoined subcomponents is the separation, or failure, of the joint that is formed during the joining procedure, when under the influence of applied loads.

Thus, an improved joint and method of joining one CMC subcomponent, or preform, to another ceramic monolithic subcomponent or CMC subcomponent to form a complete structure, is desired and would be appreciated in the art.

The present disclosure is generally related to composite panel assemblies having a composite panel joined together with another component (such as another composite panel or piece of hardware). A composite panel may include a core structure (which may be additively manufactured having one or more hollow cells and one, more interlocking features, or both) and one or more composite sheets bonded to the core structure. While composite materials provide good toughness, high thermal insulation, high-temperature strength, and chemical stability, the raw material and processing techniques can become expensive. Current structures capable of withstanding extreme operation conditions may be bulky, expensive, or have short lifespans. Accordingly, a lighter, stronger, and more cost-effective structure would be welcomed in the art. Composite panels can provide for similar properties while reducing weight of the component, and notably, the amount of ceramic material used in the component.

The present disclosure provides composite panel assemblies, constructed from composite materials, having one or more interlocking features that allow for other components to couple thereto to form an interlocking mechanical joint. These interlocking mechanical joints may include, but are not limited to, a mortise and tenon joint, a dovetail joint, an I-beam joint, grommet joints, or an T-shaped joint. The component may be another composite panel, or any other component having a suitable shape to mechanically couple to the interlocking feature in the composite panel.

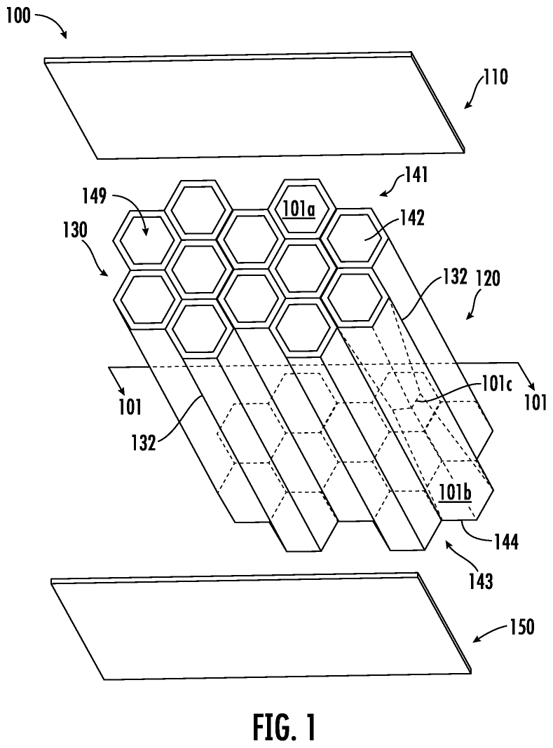

Referring now to the drawings, in which identical numerals indicate the same elements or similar elements in different embodiments throughout the figures, FIG. 1 shows an exploded view of composite panel 100 according to one or more embodiments described herein. The composite panel 100 generally comprises a core structure 120 and a first composite sheet 110 bonded to a first side 141 (or top side) of the core structure 120. In some embodiments, such as that illustrated in FIG. 1, the composite panel 100 may further comprise a second composite sheet 150 bonded to a second side 143 (or bottom side) of the core structure 120 and opposite the first side 141. The core structure 120 may define at least one face, such as a first face 142 (or top face) and a second face 144 (or bottom face). The core structure 120 may also include a cross-sectional geometry 101 that is nonuniform in a height direction between the first face 142 of the first side 141 and the second face 144 of the second side 143. Such a configuration can provide the first face 142 of the core structure 120, the second side 143 of the core structure 120, or a combination thereof to produce greater bonding with the first composite sheet 110, the second composite sheet 150, or a combination thereof where present while also producing a lighter composite panel 100 compared to a completely solid composite material.

The first composite sheet 110, the second composite sheet 150, and the core structure 120 can comprise a combination of different materials to facilitate structural and mechanical requirements for the composite panel 100. The first composite sheet 110 and the second composite sheet 150 can comprise any composite material such as a CMCs. In one particular embodiment, the composite material generally comprises a fibrous reinforcement material embedded in matrix material (as in a CMC). The reinforcement material serves as a load-bearing constituent of the composite material, while the matrix of a composite material serves to bind the fibers together and act as the medium by which an externally applied stress is transmitted and distributed to the fibers.

The core structure 120 may comprise a different material compared to the first composite sheet 110 or the second composite sheet 150. By way of non-limiting example, the core structure 120 may be a material that is less dense than the material of the first composite sheet 110 or the second composite sheet 150. However, even when the material of the core structure 120 is different, it is compatible with the first composite sheet 110 and the second composite sheet 150 to produce a sufficient bond between the components, including in extreme operating conditions such as high temperatures. In exemplary embodiments, the core structure 120 may include silicon, silicon carbide, alumina, carbon, or aluminosilicates, or combinations thereof. However, in exemplary embodiments, the core structure 120 may comprise the same material as the first composite sheet 110 or the second composite sheet 150.

As illustrated in FIG. 1, the core structure 120 comprises a plurality of hollow cells 130 defined by a plurality of lattice walls 132 extending from a first face 142 on a first side 141 to a second face 144 on a second side 143, opposite the first side 141. In the illustrated example, the first side 141 is on the top and the second side 143 is on the bottom. Each of the plurality of hollow cells 130 that form the core structure 120 can extend in a parallel direction with one another. Moreover, each first face 142 for each of the plurality of hollow cells 130 may be planar with one another so that the first side 141 of the core structure 120 comprises a substantially flat plane comprising a plurality of first faces 142 from the plurality of hollow cells 130. Likewise, each second face 144 for each of the plurality of hollow cells 130 may be planar with one another so that the bottom side 143 of the core structure 120 comprises a substantially flat plane comprising a plurality of second faces 144 from the plurality of hollow cells 130. In such embodiments, the first faces 142 and the second faces 144 may be parallel with one another such the first composite sheet 110 being bonded to the first side 141 of the core structure 120 will be parallel with the second composite sheet 150 being bonded to the bottom side 143 of the core structure 120.

While the core structure 120 in FIG. 1 is illustrated as having a plurality of hollow cells 130 that are parallel with one another, are the same length as one another, and comprise a first side 141 parallel with a bottom side 143, it should be appreciated that a variety of alternative or additional configurations may also be realized within the scope of this disclosure. For example, the plurality of hollow cells 130 may comprise different lengths, may comprise different orientations, may produce first sides 141 and bottom sides 143 that are not planar or not parallel with one another, or any combination thereof.

As illustrated in FIG. 1, the plurality of lattice walls 132 of the plurality of hollow cells 130 define the shape, and more specifically, the cross-sectional geometry 101, of each of the plurality of hollow cells 130. That is, the plurality of lattice walls 132 create a partially closed structure (i.e., enclosed by the plurality of lattice walls 132 on the side but potentially open on the ends at the first face 142 or the second face 144) to define a hollow interior 149 to form a cross-sectional geometry 101 for each of the plurality of cells. As used herein, the cross-sectional geometry 101 refers to the open, or closed, space between the plurality of lattice walls 132 at any point along the length of any individual cell. For example, each cell 130 has a first cross-sectional geometry 101a at its first face 142 at the first side 141 of the core structure 120, and a bottom cross-sectional geometry 101b at its second face 144 at the bottom side 143 of the core structure 120. The plurality of lattice walls 132 may be brought together to form the plurality of hollow cells 130 using a variety of different techniques. For instance, as a non-limiting example, the plurality of lattice walls 132 may be unitarily formed, monolithically formed, or unitarily and monolithically formed.

The cross-sectional geometry 101 can comprise a variety of different shapes within each of the plurality of hollow cells 130. For example, as shown in the embodiment of FIG. 1, the cross-sectional geometry 101 of each hollow cell 130 may be a hexagon. That is, each hollow cell 130 of the plurality of hollow cells 130 may have a hexagonal shape. However, the plurality of hollow cells 130 may have cross-sectional geometries 101 that are different, e.g., where the cross-sectional geometry 101 is one of a hexagon, circle, square, or a triangle in non-limiting examples.

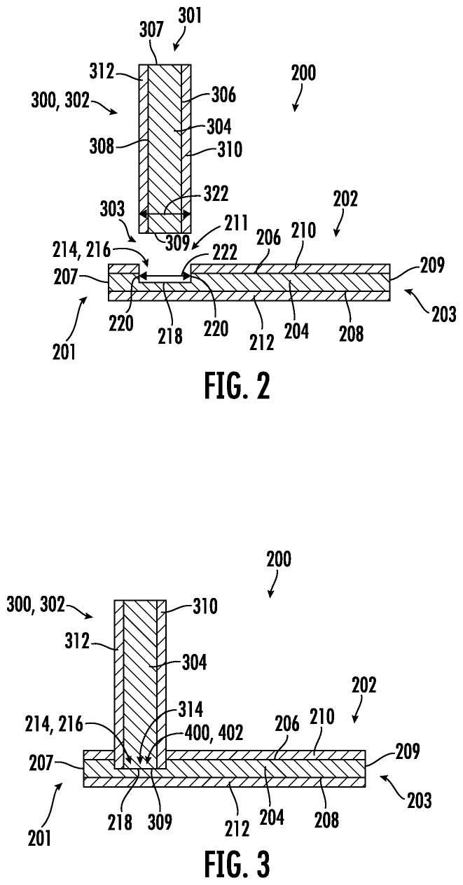

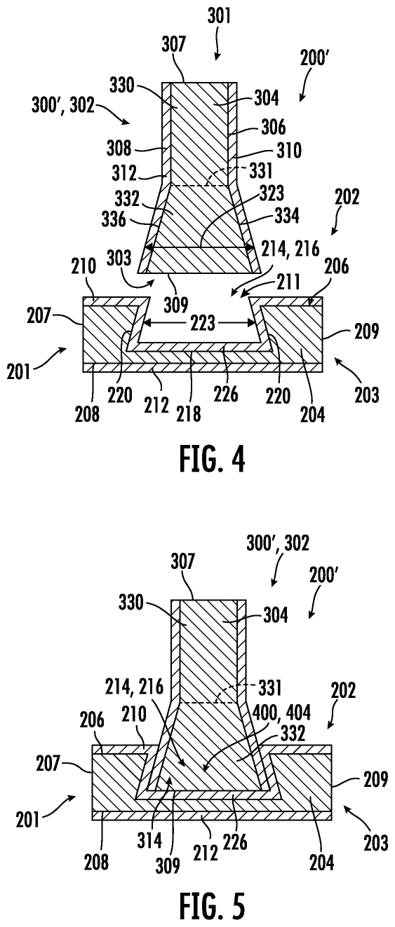

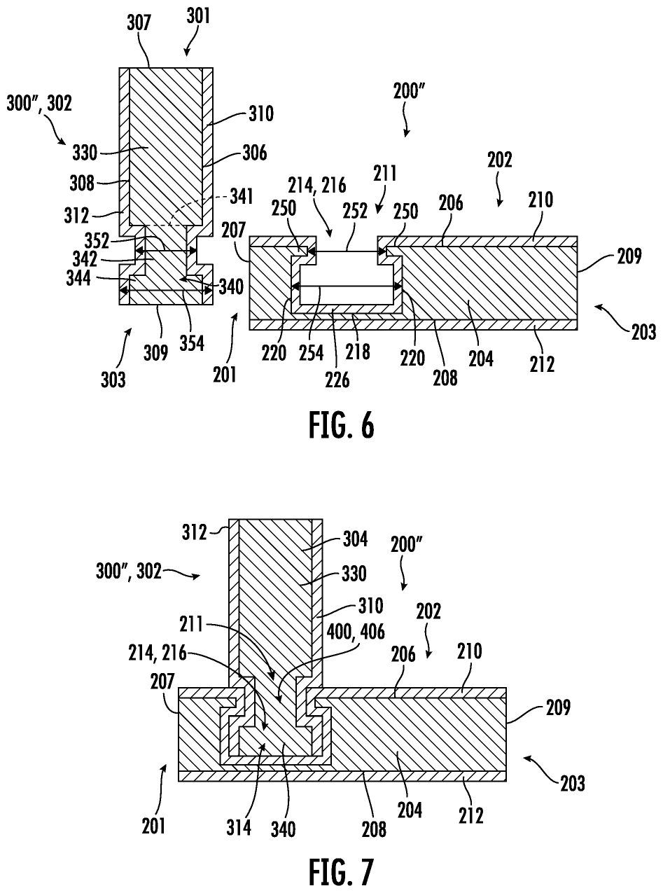

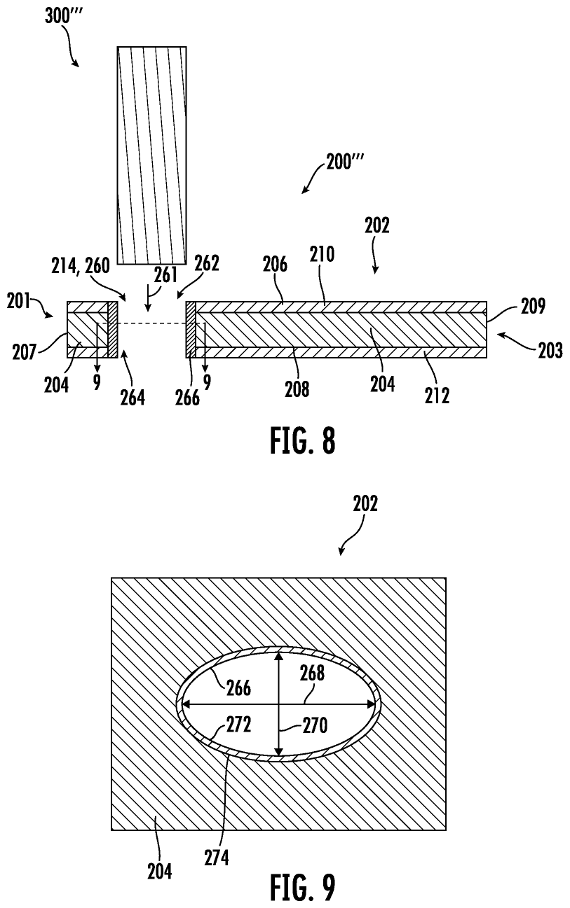

FIGS. 2 through 9 each illustrate embodiments of a composite panel assemblies according to the present disclosure. Particularly, FIGS. 2 and 3 illustrate a composite panel assembly 200 in accordance with a first embodiment of the present disclosure; FIGS. 4 and 5 illustrate a composite panel assembly 200′ in accordance with a second embodiment of the present disclosure; FIGS. 6 and 7 illustrate a composite panel assembly 200″ in accordance with a third embodiment of the present disclosure; and FIGS. 8 and 9 illustrate a composite panel assembly 200′″ in accordance with a fourth embodiment of the present disclosure.

As shown in FIGS. 2 through 9, each of the respective composite panel assemblies 200, 200′, 200″, 200′″ may include a respective first composite panel 202, 202′, 202″, 202′″ and a respective component 300, 300′, 300″, 300′″. It is to be understood that the same reference number refers to a similar or equivalent element in the various embodiments discussed herein.

Referring to FIGS. 2 and 3, the composite assembly 200 includes a first composite panel 202 and a respective component 300 that is a second composite panel 302. However, in other embodiments, the component 300 may not be a composite panel (e.g., may be a CMC or other suitable material). In the embodiment shown, the first composite panel 202 and the second composite panel 302 may each have a similar construction as the composite panel 100, described above with reference to FIG. 1. In certain embodiments, the first composite panel 202 and the second composite panel 302 may each incorporate one or more of the features of the composite panel 100 described above with reference to FIG. 1, such as the core structure 120 having the plurality of hollow cells 130, the plurality of lattice walls 132, the hexagonal cross sectional shape, or other features.

The first composite panel 202 may include a first core structure 204, a first composite panel first composite sheet 210, and a first composite panel second composite sheet 212. The first core structure 204 may have (or define) a first core structure first face 206 and a first core structure second face 208 opposite the first core structure first face 206. The first composite panel first composite sheet 210 may be bonded to the first core structure first face 206, and the first composite panel second composite sheet 212 may be bonded to the first core structure second face 208. The first core structure 204 may be an unreinforced ceramic material (e.g., free from fibers therein), such as configured the same as the core structure 120 described above with reference to FIG. 1. The first composite panel 202 may extend between a first end 201 and a second end 203. The first core structure 204 may further define a first end wall 207 at the first end 201 of the first composite panel 202 and a second end face 209 at the second end 203 of the first composite panel 202. An interlocking feature 214 (such as a groove, aperture, void, cavity, or other first feature) may be defined in the first core structure 204. For example, the first core structure 204 may be additively manufactured having the groove 216.

Similarly, the second composite panel 302 may include a second core structure 304, a second composite panel first composite sheet 310, and a second composite panel second composite sheet 312. The second core structure 304 may have (or define) a second core structure first face 306 and a second core structure second face 308 opposite the second core structure first face 306. The second composite panel first composite sheet 310 may be bonded to the second core structure first face 306, and the second composite panel second composite sheet 312 may be bonded to the second core structure second face 308. The second core structure 304 may be configured the same as the core structure 120 described above with reference to FIG. 1, in many embodiments. The second composite panel 302 may extend between a first end 301 and a second end 303. The second core structure 304 may further define a first end wall 307 at the first end 301 of the second composite panel 302 and a second end wall 309 at the second end 303 of the second composite panel 302. A portion 314 may be included in the component 300, the portion 314 may extends into the interlocking feature 214 such that an interlocking mechanical joint 400 is formed between the first composite panel 202 and the component 300 (e.g., between the first composite panel 202 and the second composite panel 302).

For example, the interlocking feature 214 may be a groove 216 having various shapes. In the illustrated example of FIG. 2 the groove is a channel. The portion 314 of the component 300 may correspond to the shape of the groove 216, such that the portion 314 may be inserted into the groove 216 to form the interlocking mechanical joint 400 between the component 300 and the first composite panel 202. In the embodiment of FIGS. 2 and 3, the interlocking mechanical joint 400 is one of a dado joint or a mortise and tenon joint 402. In the embodiment of FIGS. 4 and 5, the interlocking mechanical joint 400 is a dovetail joint 404. In the embodiment of FIGS. 6 and 7, the interlocking mechanical joint is a T-shaped joint 406.

In many embodiments, the first composite panel 202 may be oriented generally orthogonally to the second composite panel 302. For example, the first composite panel 202 and the second composite panel 302 may each extend along an axial centerline, and the axial centerline of the first composite panel 202 may be generally perpendicular to the axial centerline of the second composite panel 302 in many embodiments.

The composite sheets 210, 212, 310, 312 may each have a thickness T that is much smaller than a thickness of the core structures 204, 304. For example, the thickness T may be between about 1% and about 30% of a thickness of the core structures 204, 304, or such as between about 1% and about 20%, or such as between about 1% and about 10%, or such as between about 1% and about 10%, or such as between about 1% and about 5%.

As stated, the interlocking mechanical joint 400 may be the mortise and tenon joint 402 (or a dado joint) in the embodiment shown in FIGS. 2 and 3. FIG. 2 illustrates a partially exploded view of the composite panel assembly 200, in which the first composite panel 202 and the second composite panel 302 are separated (e.g., prior to the portion 314 of the second composite panel 302 being inserted into the groove 216 of the first composite panel 202). FIG. 3 illustrates the composite panel assembly 200 fully assembled, either before or after bonding therebetween. As shown, the first core structure 204 may define the groove 216 between the first end wall 207 and the second end face 209. The groove 216 may extend from the first core structure first face 206 towards (but not through) the first core structure second face 208. The groove 216 may be defined by a floor 218 and at least one side wall 220. The at least one side wall 220 may be annular in some embodiments. In other embodiments, the at least one side wall 220 may include a first side wall and a second side wall spaced apart from one another. The at least one side wall 220 may be generally perpendicular to the floor 218 and/or the first core structure first face 206.

The first composite panel first composite sheet 210 may define an opening 211 that aligns with the groove 216. The opening 211 may have the same width as the groove 216 at the first core structure first face 206 and may receive the portion 314 of the component 300. Such that the portion 314 may extend though the opening 211 of the first composite panel first composite sheet 210 and into the groove 216.

In the embodiment shown in FIGS. 2 and 3, the groove 216 of the first composite panel 202 and the portion 314 of the second composite panel 302 may each have a uniform width. That is, the groove 216 may include a first uniform width 222 (e.g., between a first wall or side of the at least one side wall 220 and a second wall or side of the at least one side wall 220). The portion 314 of the second composite panel 302 may define a second uniform width 322 (e.g., between an exterior top surface of the second composite panel first composite sheet 310 and an exterior bottom surface of the second composite panel second composite sheet 312). The first uniform width 222 and the second uniform width 322 may be approximately equal (e.g., within about 0% to about 5% difference, or within about 0% and about 1% difference), such that the portion 314 of the second composite panel 302 forms an interference fit (or friction fit) with the second composite panel 302 within the groove 216 (e.g., to form the interlocking mechanical joint 400). The first composite panel 202 and second composite panel 302, once interlocked to each other, may be joined with a suitable bonding agent, such as silicon or silicon alloys, matrix precursors that cure into a solid matrix, seal glasses, or combinations thereof.

Referring now specifically to FIGS. 4 and 5, as shown, the interlocking mechanical joint 400 may be the dovetail joint 404. FIG. 4 illustrates a partially exploded view of the composite panel assembly 200, in which the first composite panel 202 and the second composite panel 302 are separated (e.g., prior to the portion 314 of the second composite panel 302 being inserted into the groove 216 of the first composite panel 202). FIG. 5 illustrates the composite panel assembly 200 fully assembled. As shown, the first core structure 204 may define the groove 216 between the first end wall 207 and the second end face 209. The groove 216 may extend from the first core structure first face 206 towards (but not through) the first core structure second face 208. The groove 216 may be defined by a floor 218 and at least one side wall 220. The at least one side wall 220 may be annular in some embodiments. In other embodiments, the at least one side wall 220 may include a first side wall and a second side wall spaced apart from one another. As shown in FIGS. 4 and 5, the at least one side wall 220 may be angled, slanted, or sloped with respect to the floor 218 and/or the first core structure first face 206 (e.g., the at least one side wall 220 may be oblique relative to the floor 218 and/or the first core structure first face 206).

The second core structure 304 second composite panel 302 may include a main body 330 and a dovetail portion 332 extending from the main body 330. The main body 330 may extend from the first end wall 307 to a base 331 of the dovetail portion 332. The dovetail portion 332 may extend from the base 331 to the second end wall 309. The dovetail portion 332 may include a dovetail top surface 334 and a dovetail bottom surface 336, which may be slanted relative to the second end wall 309 (e.g., generally oblique to the second end wall 309). The dovetail top surface 334 may be a portion of the second core structure first face 306, and the dovetail bottom surface 336 may form a portion of the second core structure second face 308.

The first composite panel first composite sheet 210 may define an opening 211 that aligns with the groove 216. The opening 211 may have the same width as the groove 216 at the first core structure first face 206 and may receive the portion 314 of the component 300. The portion 314 is part of the dovetail portion 332 that extends though the opening 211 of the first composite panel first composite sheet 210 and into the groove 216. It will be appreciated that the portion 314 would be slid into the groove 216 from a side of the first composite panel first composite sheet 210.

Still referring to FIGS. 4 and 5, the interlocking feature 214 may be a groove 216 that forms a dovetail joint 404. In the shown embodiment, the first composite panel 202 may further include a composite liner 226 disposed within the groove 216. The composite liner 226 may be formed from the same material as the first composite panel first composite sheet 210 and the first composite panel second composite sheet 212. In some embodiments, as shown in FIGS. 4 and 5, the composite liner 226 may be an extension of (or a portion of) the first composite panel first composite sheet 210, such that the first composite panel first composite sheet 210 extends continuously through the groove 216 (e.g., along the at least one side wall 220 and the floor 218). As another example not shown in the Figures, the composite liner 226 may be a separate piece that extends along, and is bonded to, the at least one side wall 220 and the floor 218. Specifically, a bonding agent such as an adhesive may bond the composite liner 226 to the at least one side wall 220. The second end wall 309 may contact, and/or be bonded to, the composite liner 226 when the composite panel assembly 200 is assembled (as shown in FIG. 5).

In the embodiment shown in FIGS. 4 and 5, the groove 216 of the first composite panel 202 and the portion 314 of the second composite panel 302 may each have a varying width. That is, the groove 216 may include a first varying width 223 that continuously increases between the first core structure first face 206 and the floor 218. The first varying width 223 may be defined between a first wall or side of the at least one side wall 220 and a second wall or side of the at least one side wall 220. Similarly, the dovetail portion 332, which includes the portion 314, may define a second varying width 323. The second varying width may continuously increase between the base 331 of the dovetail portion 332 and the second end wall 309. The second varying width 323 may be defined between an exterior top surface of the second composite panel first composite sheet 310 and an exterior bottom surface of the second composite panel second composite sheet 312). The dovetail portion 332, including the portion 314 of the second composite panel 302, may form an interference fit (or friction fit) with the first composite panel 202 within the groove 216 (e.g., to form the interlocking mechanical joint 400).

Referring now specifically to FIGS. 6 and 7, as shown, the interlocking mechanical joint 400 may be the T-shaped joint 406. FIG. 6 illustrates a partially exploded view of the composite panel assembly 200, in which the first composite panel 202 and the second composite panel 302 are separated (e.g., prior to the portion 314 of the second composite panel 302 being inserted into the groove 216 of the first composite panel 202). FIG. 7 illustrates the composite panel assembly 200 fully assembled. As shown, the first core structure 204 may define the groove 216 between the first end wall 207 and the second end face 209. The groove 216 may be T-shaped in the embodiment shown in FIGS. 6 and 7. The groove 216 may extend from the first core structure first face 206 towards (but not through) the first core structure second face 208. The first core structure 204 may include a pair of tabs 250 that defines an opening to the groove 216 that defines a stem of the T-shape. The groove 216 may be further defined by a floor 218 and at least one side wall 220, which allow the groove 216 to extend beyond the tabs 250 to form a flange of the T-shape. That is, the portion of the first composite panel first composite sheet 210 that extends around the tabs 250 defines the stem of the T-shape, and the at least one side wall 220 and the floor 218 define the flange of the T-shape. The at least one side wall 220 may be annular in some embodiments. In other embodiments, the at least one side wall 220 may include a first side wall and a second side wall spaced apart from one another (which may be generally parallel). As shown in FIGS. 6 and 7, the at least one side wall 220 may generally perpendicular to the floor 218 and/or the pair of tabs 250.

The second core structure 304 second composite panel 302 may include a main body 330 and a T-shaped portion 340 extending from the main body 330. The main body 330 may extend from the first end wall 307 to a base 341 of the T-shaped portion 340. The T-shaped portion 340 may include a web 342 and a flange 344 extending generally perpendicularly from the web 342. The web 342 is the vertical portion of the T-shape (also referred to as a stem of a T-shape), and the flange 344 is the horizonal portion of the T-shape extending beyond the web 342 (also referred to as an arm of a T-shape). The web 342 may extend from the base 341 to the flange 344, and the flange 344 may extend from the web 342 to the second end wall 309.

The first composite panel first composite sheet 210 may define an opening 211 that aligns with the groove 216. The opening 211 may have the same width as the groove 216 at the first core structure first face 206 and may receive the portion 314 of the component 300. Such that the portion 314 may extend though the opening 211 of the first composite panel first composite sheet 210 and into the groove 216.

In some embodiments, as shown in FIGS. 6 and 7, the first composite panel 202 may further include a composite liner 226 disposed within the groove 216. The composite liner 226 may be formed from the same material as the first composite panel first composite sheet 210 and the first composite panel second composite sheet 212. In some embodiments, the composite liner 226 may be an extension of (or a portion of) the first composite panel first composite sheet 210, such that the first composite panel first composite sheet 210 extends continuously through the groove 216 (e.g., along the pair of tabs 250, the at least one side wall 220 and the floor 218). The composite liner 226 may extend along, and be bonded to, the pair of tabs 250, the at least one side wall 220, and/or the floor 218. The second end wall 309 may contact, and/or be bonded to, the composite liner 226 at the floor 218 when the composite panel assembly 200 is assembled (as shown in FIG. 7).

In the embodiment shown in FIGS. 6 and 7, the groove 216 of the first composite panel 202 and the T-shaped portion 340, which includes the portion 314, of the second composite panel 302 may each have a two different widths. That is, the groove 216 may include a first width 252 defined between the pair of tabs 250, and a second width 254 defined between a first side wall and a second side wall of the at least one side wall 220. The second width 254 may be larger than the first width 252. Similarly, the T-shaped portion 340, which includes the portion 314, may define a first width 352 and a second width 354. The second width 354 may be larger than the first width 352. The T-shaped portion 340, including the portion 314 of the second composite panel 302, may form an interference fit (or friction fit) with the first composite panel 202 within the groove 216 (e.g., to form the interlocking mechanical joint 400).

Referring now to FIGS. 8 and 9, the interlocking feature 214 of the interlocking mechanical joint 400 may be an aperture 260, and the component 300 may be inserted into the aperture 260. For example, FIG. 8 illustrates a partially exploded view of the composite panel assembly 200, in which the first composite panel 202 and the component 300 are separated (e.g., prior to the component being inserted into the aperture 260 as indicated by arrow 261). Particularly, the interlocking feature 214 may be the aperture 260 defined through the first core structure 204. For example, the aperture 260 may be defined through the first core structure 204 between the first core structure first face 206 and the first core structure second face 208. The first composite panel first composite sheet 210 may define a first opening 262, and the first composite panel second composite sheet 212 may define a second opening 264. The first opening 262 and the second opening 264 may align with the aperture 260 (such that the openings 262, 264 and the aperture 260 are coaxial).

In exemplary embodiments, as shown, a composite grommet 266 may be disposed within the aperture 260 and bonded to the first core structure 204. In some embodiments, the composite grommet 266 may extend through one or both of the openings 262, 264 and the aperture 260 and be bonded to the first core structure 204, bonded to the first composite panel first composite sheet 210, and/or bonded to the first composite panel second composite sheet 212. The composite grommet 266 may be formed from the same material as the first composite panel first composite sheet 210 and/or the first composite panel second composite sheet 212 (e.g., silicon, silicon carbide, alumina, carbon, or aluminosilicates, or combinations thereof). As an example, the composite grommet 266 may be a CMC tube section that is bonded to the first core structure 204 via a melt infiltration bond. The CMC material may reduce or inhibit cracking or deformation of the composite grommet 266. In such an example, the composite grommet 266 may be used when the first core structure 204 is one of a solid ceramic plate, a honeycomb plate, or a CMC plate.

In such embodiments, the component 300 may extend through the composite grommet 266 to form the interlocking mechanical joint 400 (as indicated by the arrow 261). The component 300 may be any suitable part or structure to form the interlocking mechanical joint 400. As an example, the component 300 may be a pin that extends through the composite grommet 266 to form a friction fit. As another example, the component 300 may be a bolt that passes through the composite grommet 266. As another example, the component 300 may be a CMC fastener that extends through the composite grommet 266.

FIG. 9 illustrates a cross-sectional view of the first core structure 204 from along the line 9-9 shown in FIG. 8. As shown, the composite grommet 266, and the aperture 260, may be shaped as an oval, although other shapes are possible (such as circular, rectangular, or others). That is, the composite grommet 266 may include a major axis 268 and a minor axis 270 mutually perpendicular to one another. The major axis 268 may be the longest dimension of the composite grommet 266, and the minor axis 270 may be the shortest dimension of the composite grommet 266. The composite grommet 266 may include an interior surface 272 and an exterior surface 274. The interior surface 272 may contact, surround, and couple to the component 300 when the composite assembly is fully assembled. The exterior surface 274 may be bonded to one or more of the first core structure 204, the first composite panel first composite sheet 210, and/or the first composite panel second composite sheet 212.

In some embodiments, a bonding agent, such as an adhesive or a cross-linking material, may be at least partially disposed in the interlocking mechanical joint 400 to bond the first composite panel 202 to the component 300. The bonding agent may be injected into the interlocking feature 214 (such as into the groove 216 or into the aperture 260) prior to insertion of the component 300. In many embodiments, the bonding agent may be one of silicon, silicon alloys, matrix precursors (including CMC matrix precursors), seal glasses, brazing materials, or combinations thereof. In other embodiments, a physical bonding mechanism may be used to bond the first composite panel 202 to the component. The physical bonding mechanisms may include threads, twist-locks, press fits, friction fits, or combinations thereof.

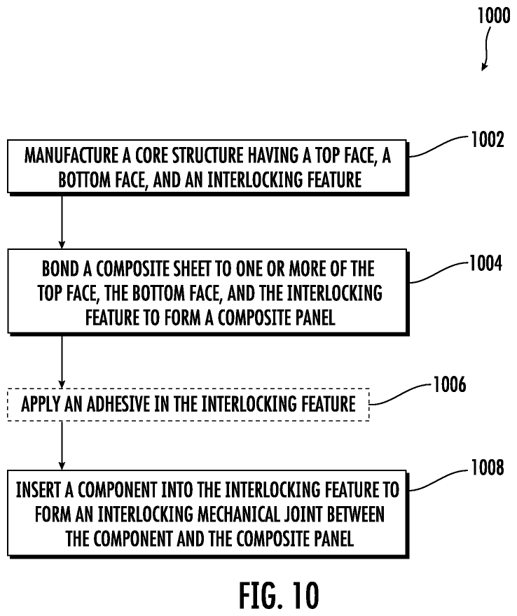

Referring now to FIG. 10, a flow diagram of one embodiment of a method 1000 of manufacturing a composite panel assembly is illustrated in accordance with embodiments of the present subject matter. In general, the method 1000 will be described herein with reference to the composite panel assembly 200 described above with reference to FIGS. 2 through 9. However, it will be appreciated by those of ordinary skill in the art that the disclosed method 1000 may generally be utilized with any suitable composite panel assembly. In addition, although FIG. 10 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure. The dashed boxes may indicate optional steps of the method 1000.

As shown in FIG. 10, the method 1000 may include at (1002) manufacturing a core structure having a first face, a second face, and, in some embodiments, an interlocking feature. The interlocking feature may be a groove defined in the core structure (FIGS. 2-7), or the interlocking feature may be an aperture defined through the core structure (FIGS. 8 and 9).

In some embodiments, manufacturing at (1002) may further include additively manufacturing the core structure. For example, all or portions of the core structure may be additively manufactured, such as via a binder jet or similar process to produce an additively manufactured core structure. In exemplary implementations, the core structure may be additively manufactured having the interlocking feature (e.g., having the groove and/or the aperture predefined therein), such that no post-machining is necessary. That is, additively manufacturing the core structure and the interlocking feature may advantageously prevent the need for post machining of the composite panel or core structure, thereby minimizing machining costs. Particularly, core structure shown in FIG. 1 may be additively manufactured to produce the plurality of hollow cells. In this way, the plurality of lattice walls may be additively manufactured by building some or all of the plurality of lattice walls in a layer-by-layer manner, such as by using a powder feedstock material. Regardless of whether the core structure is hollow or solid, additively manufacturing the core structure provides a benefit in that the interlocking features can be added to the core structure. Incorporating the interlocking features into the core structure allows for less layup tooling (the plies are layed up against the core), no ply drops or noodles for thickness build ups or to form radii of curvature, less machining of the final part resulting in lower cost, and less coated fiber also resulting in lower cost because coated fiber is only used where it is needed.

In such embodiments, additive manufacturing the plurality of lattice walls can result in a residual amount of loose unconsolidated powder feedstock in the hollow interior of each of the plurality of hollow cells. Thus, in some embodiments, the method may further comprise removing the powder feedstock from at least one of the plurality of hollow cells. For example, the powder feedstock may be poured or vacuumed out of an opening of the hollow cell. Removal the powder feedstock can further allow for the unused powder feedstock to be recycled and used to make core structures for additional composite panels or other parts of the composite panel.

While additive manufacturing is disclosed as an exemplary method for manufacturing the core structure, it should be appreciated that other ceramic processing techniques may also be utilized within the scope of this disclosure such as, for example, extrusion processing. Depending on the materials used, the manufacturing process, or other manufacturing variables, the core structure may be ready for use in the composite panel, or may require one or more further intermediate processing steps. For example, in some embodiments, the core structure may be in a green state after additive manufacturing. Thus, in such embodiments, the method may further comprise curing the core structure to remove moister or sintering the core structure.

In exemplary embodiments, the method 1000 may further include at (1004) bonding a composite sheet to one or more of the first face, the second face, and the interlocking feature to form a composite panel. Particularly, a first composite sheet may be bonded to the first face, and a second composite sheet may be bonded to the second face. A composite liner or composite grommet may be bonded to the interlocking feature, in some implementations. In some embodiments, the first face or the second face may extend across or into the interlocking feature, such as when the interlocking feature is a dovetail joint or a T-shaped joint. Bonding may include any suitable process to mechanically integrate the composite sheet with the core structure. For example, bonding at (1004) may include bonding with an adhesive. In some embodiments, bonding at (1004) may include one or more manufacturing steps utilized in manufacturing ceramic matrix composites, such as infiltration of the ceramic material or curing.

In some implementations, the method 1000 may include at (1006) applying an adhesive into the interlocking feature. The adhesive may be applied into the interlocking feature (such as into the groove or into the aperture) prior to insertion of the component to form the interlocking mechanical joint, such as by injection, spraying, or other forms of application. In many embodiments, the adhesive may be one of silicon, silicon alloys, matrix precursors, seal glasses, or combinations thereof. In implementations where the adhesive is a matrix precursor, the method may also include conversion of the matrix precursor into a matrix material (which may be done by a pre-ceramic polymer, melt infiltration, or chemical vapor infiltration).

In exemplary implementations, the method 1000 may include at (1008) inserting a component into the interlocking feature to form the interlocking mechanical joint between the component and the composite panel. This may include sliding, moving, and/or rotating the component relative to the composite panel, such that once the component is positioned within the interlocking feature (e.g., the groove or the aperture) the component cannot be removed.

The composite panel assembly 200 as disclosed and described herein may be used in a variety of industrial machines, including but not limited to one or more components of turbomachines. Moreover, the composite panel assembly 200 disclosed and described herein can provide a more cost-effective, lighter, and potentially stronger alternative to solid composite structures. However, the composite panels disclosed and described herein further provides enhanced bonding between the core structure and the composite sheets. Additionally, additively manufacturing the core structure with the interlocking feature may allow for complex, yet strong, joints between the composite panels and another component (such as another composite panel or other hardware).

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A composite panel assembly including a first composite panel having a first core structure and at least one composite sheet, the first core structure defining an interlocking feature, a first core structure first face and a first core structure second face, the first core structure second face opposite the first core structure first face, the at least one composite sheet bonded to the first core structure first face or the first core structure second face and a component having a portion configured to extend into the interlocking feature such that an interlocking mechanical joint is formed between the first composite panel and the component.

The composite panel assembly of any of the preceding clauses, wherein the interlocking feature is a groove defined in the first core structure, and wherein the portion includes a complementary shape to be received in the groove.

The composite panel assembly of any of the preceding clauses, wherein the first composite panel further includes a composite liner is bonded to the first core structure within the groove.

The composite panel assembly of any of the preceding clauses, wherein the interlocking mechanical joint is one of a dado joint, a mortise and tenon joint, a dovetail joint, and an T-shaped joint.

The composite panel assembly of any of the preceding clauses, wherein the component is a second composite panel having a second core structure and at least one second composite sheet, the second core structure defining a second core structure first face and a second core structure second face, the at least one second composite sheet bonded to the second core structure first face or the second core structure second face.

The composite panel assembly of any of the preceding clauses, wherein the first composite panel is oriented orthogonally to the second composite panel.

The composite panel assembly of any of the preceding clauses, wherein the interlocking feature is an aperture defined through the first core structure, wherein the component is a pin, a bolt, or a CMC fastener, and wherein the interlocking feature is configured to receive the component therethrough.

The composite panel assembly of any of the preceding clauses, wherein a composite grommet is disposed within the aperture and bonded to the first core structure, and wherein the component extends through the composite grommet to form the interlocking mechanical joint.

The composite panel assembly of any of the preceding clauses, wherein the first core structure further includes a plurality of hollow cells.

The composite panel assembly of any of the preceding clauses, wherein at least one of the plurality of hollow cells includes a hexagonal shape.

The composite panel assembly of any of the preceding clauses, wherein the at least one composite sheet includes a ceramic matrix composite.

The composite panel assembly of any of the preceding clauses, wherein the first core structure includes silicon, silicon carbide, alumina, carbon, aluminosilicates, or combinations thereof.

The composite panel assembly of any of the preceding clauses, wherein the first core structure is an additively manufactured core structure.

The composite panel assembly of any of the preceding clauses, wherein the interlocking mechanical joint is at least one of a sealed joint, a bonded joint, or a brazed joint.

The composite panel assembly of any of the preceding clauses, wherein the first core structure includes an unreinforced ceramic material.

A method of manufacturing a composite panel assembly, the method including manufacturing a core structure having a first face, a second face, and an interlocking feature, bonding a composite sheet to a portion of the core structure to form a composite panel, and inserting a component into the interlocking feature to form an interlocking mechanical joint between the component and the composite panel.

The method of any of the preceding clauses, further including applying an adhesive in the interlocking feature prior to inserting the component into the interlocking feature to form the interlocking mechanical joint.

The method of any of the preceding clauses, wherein the manufacturing further includes additively manufacturing the core structure having the first face, the second face, and the interlocking feature.

The method of any of the preceding clauses, wherein the composite sheet includes a ceramic matrix composite.

The method of any of the preceding clauses, wherein the core structure includes silicon, silicon carbide, alumina, carbon, aluminosilicates, or combinations thereof.

1. A composite panel assembly comprising:
a first composite panel having a first core structure and at least one composite sheet, the first core structure defining an interlocking feature, a first core structure first face and a first core structure second face, the first core structure second face opposite the first core structure first face, the at least one composite sheet bonded to the first core structure first face or the first core structure second face; and
a component having a portion configured to extend into the interlocking feature such that an interlocking mechanical joint is formed between the first composite panel and the component.

2. The composite panel assembly of claim 1, wherein the interlocking feature is a groove defined in the first core structure, and wherein the portion comprises a complementary shape to be received in the groove.

3. The composite panel assembly of claim 2, wherein the first composite panel further comprises a composite liner is bonded to the first core structure within the groove.

4. The composite panel assembly of claim 2, wherein the interlocking mechanical joint is one of a dado joint, a mortise and tenon joint, a dovetail joint, and an T-shaped joint.

5. The composite panel assembly of claim 1, wherein the component is a second composite panel having a second core structure and at least one second composite sheet, the second core structure defining a second core structure first face and a second core structure second face, the at least one second composite sheet bonded to the second core structure first face or the second core structure second face.

6. The composite panel assembly of claim 5, wherein the first composite panel is oriented orthogonally to the second composite panel.

7. The composite panel assembly of claim 1, wherein the interlocking feature is an aperture defined through the first core structure, wherein the component is a pin, a bolt, or a CMC fastener, and wherein the interlocking feature is configured to receive the component therethrough.

8. The composite panel assembly of claim 7, wherein a composite grommet is disposed within the aperture and bonded to the first core structure, and wherein the component extends through the composite grommet to form the interlocking mechanical joint.

9. The composite panel assembly of claim 1, wherein the first core structure further comprises a plurality of hollow cells.

10. The composite panel assembly of claim 9, wherein at least one of the plurality of hollow cells comprises a hexagonal shape.

11. The composite panel assembly of claim 1, wherein the at least one composite sheet comprises a ceramic matrix composite.

12. The composite panel assembly of claim 1, wherein the first core structure comprises silicon, silicon carbide, alumina, carbon, aluminosilicates, or combinations thereof.

13. The composite panel assembly of claim 1, wherein the first core structure is an additively manufactured core structure.

14. The composite panel assembly of claim 1, wherein the interlocking mechanical joint is at least one of a sealed joint, a bonded joint, or a brazed joint.

15. The composite panel assembly of claim 1, wherein the first core structure comprises an unreinforced ceramic material.

16. A method of manufacturing a composite panel assembly, the method comprising:
manufacturing a core structure having a first face, a second face, and an interlocking feature;
bonding a composite sheet to a portion of the core structure to form a composite panel; and
inserting a component into the interlocking feature to form an interlocking mechanical joint between the component and the composite panel.

17. The method of claim 16, further comprising applying an adhesive in the interlocking feature prior to inserting the component into the interlocking feature to form the interlocking mechanical joint.

18. The method of claim 16, wherein the manufacturing further comprises:
additively manufacturing the core structure having the first face, the second face, and the interlocking feature.

19. The method of claim 16, wherein the composite sheet comprises a ceramic matrix composite.

20. The method of claim 16, wherein the core structure comprises silicon, silicon carbide, alumina, carbon, aluminosilicates, or combinations thereof.
